(19) United States
(12) Patent Application Publication
(10) Pub. No.: US 2026/0358638 A1
(43) Pub. Date: Nov. 12, 2026

(54) OPTICAL DEVICE AND ELECTRONIC DEVICE INCLUDING SAME

(71) Applicant: LG INNOTEK CO., LTD., Seoul (KR)

(72) Inventors: Deok Won SEO, Seoul (KR); Ho Jin PARK, Seoul (KR)

(21) Appl. No.: 19/470,470

(22) PCT Filed: Mar. 29, 2024
(86) PCT No.: PCT/KR2024/004005

§ 371 Date: Sep. 29, 2025

(30) Foreign Application Priority Data
Mar. 29, 2023 (KR) 10-2023-0041473
Mar. 29, 2023 (KR) 10-2023-0041474
Mar. 28, 2024 (KR) 10-2024-0042510
Mar. 28, 2024 (KR) 10-2024-0042611

(51) Int. Cl. G02B 27/01

(52) U.S. Cl. CPC G02B 27/0172; G02B 2027/0178

(57) ABSTRACT

An embodiment provides an optical device comprising: a light source unit; a light modulator which is arranged to be spaced apart from the light source unit; a reflective member which reflects light, emitted from the light source unit, to the light modulator; an optical member which is arranged adjacent to the light source unit; a first optical element which is disposed within the optical member; and multiple second optical elements which are disposed between the light modulator and the first optical elements which are disposed between the light modulator and the first optical element within the optical member, wherein the optical member overlaps the light modulator in a first direction, and the first direction is a direction from the first optical element toward the light modulator.

### TECHNICAL FIELD

Embodiments relate to an optical device and an electronic device including the same.

### BACKGROUND ART

Virtual reality (VR) refers to a specific environment or situation, or the technology itself, which is similar to reality but not real, generated by artificial technology using computers or the like.

Augmented reality (AR) is a technology that synthesizes virtual objects or information with the real environment to make the resultants look like objects existing in the original environment.

Mixed reality (MR) or hybrid reality refers to generating new environments or new information by combining the virtual world and the real world. Particularly, it is called mixed reality when it refers to the ability to interact in real time between things existing in reality and things existing in the virtual world in real time.

In this case, the generated virtual environment, situation, or the like stimulates the users' five senses and allows them to freely move between reality and imagination by providing spatial and temporal experiences similar to reality. Additionally, the users can not only simply immerse themselves in these environments, but also interact with things implemented in these environments, such as by manipulating or giving commands using real devices.

Recently, research on apparatuses (gear, devices) used in these technical fields has been actively conducted. However, there is a growing need for miniaturization and improved optical performance of these apparatuses.

### DETAILED DESCRIPTION OF INVENTION

### Technical Problem

Embodiments provide an optical device and an electronic device having improved miniaturization and optical efficiency by providing an image emission portion on an optical member to be used as the optical device used and the electronic device including the same for augmented reality (AR) or the like.

In addition, an optical device and an electronic device with improved light transmission efficiency and improved energy efficiency may be provided compared to a case using a waveguide or the like by positioning an optical modulator and a light source unit above/below a frame to form an optical path in the optical member.

In addition, it is possible to provide an optical device and an electronic device in which reliability degradation and lifetime degradation due to heat generation are resolved by supplying less energy to the light source unit due to improved light transmission efficiency.

Embodiments provide an optical device and an electronic device in which optical efficiency is improved through a guide unit and a first optical element corresponding thereto, thereby eliminating reliability degradation and lifetime degradation due to heat generation by supplying less energy to the light source unit to be used as an optical device used and an electronic device including the same for AR or the like.

In addition, an optical device and an electronic device having improved optical performance may be provided through the shape of the first optical element.

The problems to be solved by the embodiments are not limited thereto, and purposes or effects which may be grasped from solutions or embodiments of the problems to be described below are also included.

### Technical Solution

An optical device according to an embodiment includes: a light source unit; an optical modulator disposed spaced apart from the light source unit; a reflective member that reflects light emitted from the light source unit to the optical modulator; an optical member disposed adjacent to the light source unit; a first optical element disposed in the optical member; and a plurality of second optical elements disposed between the optical modulator and the first optical element in the optical member, wherein the optical member overlaps the optical modulator in a first direction, and the first direction is a direction from the first optical element toward the optical modulator.

The optical modulator may be disposed on an upper surface of the optical member and may overlap the light source in a second direction perpendicular to the first direction.

At least a part of the optical modulator may overlap the first optical element in the first direction.

A center of the optical modulator may correspond to a center of the first optical element in a second direction.

The center of the optical modulator may be located within 0.2 times a length in the second direction from the center of the first optical element in the second direction.

A center of at least one of the plurality of second optical elements, the first optical element, and the optical modulator may be disposed to be misaligned with a center of the optical member.

A length of the optical modulator in a third direction may be greater than a length of the first optical element in the third direction, and the third direction may be a direction perpendicular to the first direction.

A length of the optical modulator in a second direction may be less than or equal to a length of the plurality of second optical elements or the first optical element in the second direction.

The first optical element may reflect the light reflected from the optical modulator to the plurality of second optical elements.

At least a part of the first optical element may be offset from the optical modulator in the first direction.

A length of the optical member in a third direction may be greater than or equal to a length of the first optical element in the third direction.

A length of the optical member in a third direction may be greater than or equal to a length of the optical modulator in the third direction.

The plurality of second optical elements may be offset from or overlap the first optical element in the first direction.

The light source unit may include a first light source and a second light source, and the optical modulator may be disposed between the first light source and the second light source.

The first optical element and the second optical element may be disposed closer to one side surface of the optical member than to the other side surface.

An electronic device according to an embodiment includes: a frame; and an optical device mounted on the frame; wherein the optical device includes: a light source unit; an optical modulator disposed spaced apart from the light source unit; a reflective member configured to reflect light emitted from the light source unit to the optical modulator; an optical member disposed adjacent to the light source unit; a first optical element disposed in the optical member; and a plurality of second optical elements disposed between the optical modulator and the first optical element in the optical member, the optical member overlaps the optical modulator in a first direction, and the first direction is a direction from the first optical element toward the optical modulator.

An optical device according to an embodiment includes: a projector; a guide unit including a reflection region that guides light emitted from the projector and reflects the light in one direction; an optical member to which the light guided by the guide unit is provided; a first optical element disposed in the optical member; and a second optical element disposed between the first optical element and the guide unit, wherein the first optical element overlaps the guide unit in the one direction.

A maximum length of the reflection region may be less than or equal to a maximum length of the first optical element.

A maximum length of the first optical element may be greater than a maximum length of the second optical element.

The second optical element may form an eye box.

The reflection region may overlap the second optical element and the first optical element in the one direction.

The guide unit and the first optical element may be disposed adjacent to a long side or a short side of the optical member.

The first optical element may be concave toward the guide unit.

A center of the first optical element or a center of the second optical element may be disposed to be misaligned with a center of the optical member.

The second optical element may include a pinhole.

An electronic device according to an embodiment includes: a frame; and an optical device disposed on the frame; wherein the optical device includes: a projector; a guide unit including a reflection region that guides light emitted from the projector and reflects the light in one direction; an optical member to which the light guided by the guide unit is provided; a first optical element disposed in the optical member; and a second optical element disposed between the first optical element and the guide unit, wherein the first optical element overlaps the guide unit in the one direction.

### Advantageous Effects

Embodiments implement an optical device and an electronic device having improved miniaturization and optical efficiency by providing an image emission portion on an optical member to be used as an optical device used and an electronic device including the same for augmented reality (AR) or the like.

In addition, an optical device and an electronic device with improved light transmission efficiency and improved energy efficiency can be implemented compared to a case using a waveguide or the like by positioning an optical modulator and a light source unit above/below a frame to form an optical path in the optical member.

In addition, it is possible to implement an optical device and an electronic device in which reliability degradation and lifetime degradation due to heat generation are resolved by supplying less energy to the light source unit due to improved light transmission efficiency.

Embodiments can implement an optical device and an electronic device in which optical efficiency is improved through a guide unit and a first optical element corresponding thereto, thereby eliminating reliability degradation and lifetime degradation due to heat generation by supplying less energy to the light source unit to be used as an optical device used and an electronic device including the same for AR or the like.

In addition, an optical device and an electronic device having improved optical performance can be implement through the shape of the first optical element.

Various useful advantages and effects of the present invention are not limited to the above-described contents, and can be more easily understood in a process of describing specific embodiments of the present invention.

### DESCRIPTION OF DRAWINGS

FIG. 1 is a block diagram showing a configuration of an extended reality electronic device according to an embodiment of the present invention.

FIG. 2 is a schematic perspective view of an augmented reality electronic device according to the embodiment of the present invention.

FIG. 3 is a schematic front view of the augmented reality electronic device according to the embodiment of the present invention.

FIG. 4 is a perspective view of an electronic device including an optical device according to a first embodiment.

FIG. 5 is a perspective view of the optical device according to the first embodiment.

FIG. 6 is a front view of the optical device according to the first embodiment.

FIG. 7 is a side view of the optical device according to the first embodiment.

FIG. 8 is a perspective view of an electronic device including an optical device according to a second embodiment.

FIG. 9 is a perspective view of the optical device according to the second embodiment.

FIG. 10 is a front view of the optical device according to the second embodiment.

FIG. 11 is a side view of the optical device according to the second embodiment.

FIG. 12 is a perspective view of an electronic device including an optical device according to a third embodiment.

FIG. 13 is a perspective view of the optical device according to the third embodiment.

FIG. 14 is a front view of the optical device according to the third embodiment.

FIG. 15 is a side view of the optical device according to the third embodiment.

FIG. 16 is a schematic perspective view of an augmented reality electronic device according to another embodiment of the present invention.

FIG. 17 is a perspective view of an electronic device including an optical device according to a fourth embodiment.

FIG. 18 is a perspective view of the optical device according to the fourth embodiment.

FIG. 19 is a front view of the optical device according to the fourth embodiment.

FIG. 20 is a side view of the optical device according to the fourth embodiment.

FIG. 21 is a perspective view of an electronic device including an optical device according to a fifth embodiment.

FIG. 22 is a perspective view of the optical device according to the fifth embodiment.

FIG. 23 is a front view of the optical device according to the fifth embodiment.

FIG. 24 is a side view of the optical device according to the fifth embodiment.

### MODES OF THE INVENTION

Hereinafter, exemplary embodiments of the present invention will be described in detail with reference to the attached drawings.

However, the technical idea of the present invention is not limited to some embodiments to be described, but can be implemented in various different forms, and within the scope of the technical idea of the present invention, one or more of the components among the embodiments can be selectively combined or substituted and used.

In addition, terms (including technical and scientific terms) used in the embodiments of the present invention can be interpreted as having a meaning that can be generally understood by a person of ordinary skill in the technical field to which the present invention belongs, unless explicitly and specifically defined and described, and terms that are commonly used, such as terms defined in a dictionary, can be interpreted in consideration of the contextual meaning of the relevant technology.

Additionally, the terms used in the embodiments of the present invention are for the purpose of describing the embodiments and are not intended to limit the present invention.

In this specification, the singular may also include the plural unless specifically stated otherwise in the phrase, and when it is described as “at least one (or one or more) of A, B, and C,” it may include one or more of all combinations in which A, B, and C can be combined.

Additionally, in describing components of embodiments of the present invention, terms such as first, second, A, B, (a), (b), and the like may be used.

These terms are only intended to distinguish one component from another, and the nature, order, sequence, and the like of the component are not limited by these terms.

Further, when a certain component is described as being ‘connected,’ ‘coupled,’ or ‘joined’ to another component, it may include not only cases where the component is directly connected, coupled, or joined to the other component, but also cases where the component is ‘connected,’ ‘coupled,’ or ‘joined’ by still another component between the component and the other component.

Additionally, when one component is described as being formed or disposed “above (upper) or below (lower)” another component, above (upper) or below (lower) includes not only cases where the two components are in direct contact with each other, but also cases where one or more still other components are formed or disposed between the two components. Additionally, when expressed as “above (upper) or below (lower),” it may include the meaning of not only the upward direction but also the downward direction based on one component.

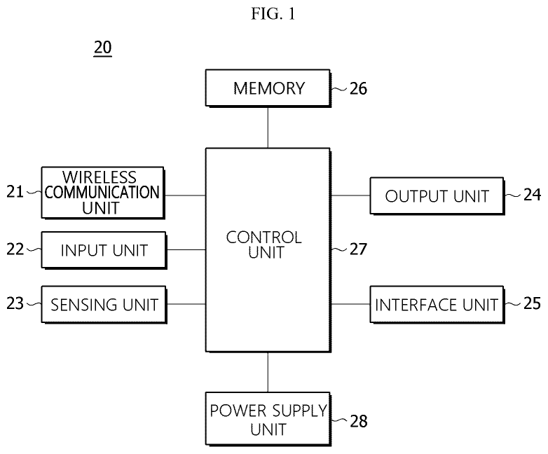

FIG. 1 is a block diagram showing the configuration of an extended reality electronic device according to an embodiment of the present invention.

Referring to FIG. 1, an extended reality electronic device 20 may include a wireless communication unit 21, an input unit 22, a sensing unit 23, an output unit 24, an interface unit 25, a memory 26, a control unit 27, a power supply unit 28, and the like. The components illustrated in FIG. 1 are not essential for implementing the electronic device 20, and thus the electronic device 20 described in this specification may have more or fewer components than the components listed above.

More specifically, among the above components, the wireless communication unit 21 may include one or more modules that enable wireless communication between the electronic device 20 and a wireless communication system, between the electronic device 20 and another electronic device, or between the electronic device 20 and an external server. Additionally, the wireless communication unit 21 may include one or more modules that connect the electronic device 20 to one or more networks.

The wireless communication unit 21 may include at least one of a broadcast reception module, a mobile communication module, a wireless Internet module, a short-range communication module, and a position information module.

The input unit 22 may include a camera or a video input unit for video signal input, a microphone or an audio input unit for audio signal input, and a user input unit (for example, a touch key, a push key (mechanical key), etc.) for receiving information from a user. Voice data or image data collected from the input unit 22 may be analyzed and processed with the user's control commands.

The sensing unit 23 may include one or more sensors for detecting at least one of information in the electronic device 20, information about the surrounding environment surrounding the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensor (for example, a photographing means), a microphone, a battery gauge, an environmental sensor (for example, a barometer, a hygrometer, a thermometer, a radiation detection sensor, a heat detection sensor, a gas detection sensor, etc.), and a chemical sensor (for example, an electronic nose, a healthcare sensor, a biometric recognition sensor, etc.). Meanwhile, the electronic device 20 disclosed in this specification may utilize information detected by at least two of these sensors in combination.

The output unit 24 may be for generating output related to vision, hearing, tactile sensations, or the like and may include at least one of a display unit, an audio output unit, a haptic module, and an optical output unit. The display unit may be implemented as a touch screen by forming a mutual layer structure with the touch sensor or by being integrated with the touch sensor. The touch screen may function as a user input means that provides an input interface between the augmented reality electronic device 20 and the user, and at the same time, may provide an output interface between the augmented reality electronic device 20 and the user.

The interface unit 25 functions as a passageway for various types of external devices connected to the electronic device 20. Through the interface unit 25, the electronic device 20 may receive virtual reality or augmented reality content supplied from an external device and perform mutual interaction by transmitting and receiving various input signals, detecting signals, and data.

For example, the interface unit 25 may include at least one of a wired/wireless headset port, an external charger port, a wired/wireless data port, a memory card port, a port for connecting a device provided with an identification module, an audio input/output (I/O) port, a video input/output (I/O) port, and an earphone port.

Additionally, the memory 26 may store data that supports various functions of the electronic device 20. The memory 26 may store a plurality of application programs (or applications) driven by the electronic device 20, data for the operation of the electronic device 20, and commands. At least some of these application programs may be downloaded from external servers through wireless communication. Additionally, at least some of these application programs may be present on the electronic device 20 from the time of shipment for basic functions of the electronic device 20 (for example, incoming and outgoing call functions, message receiving and outgoing functions).

In addition to the operations related to the application program, the control unit 27 may typically control the overall operation of the electronic device 20. The control unit 27 may process signals, data, information, and the like input or output through the above-described components.

In addition, the control unit 27 may control at least some of the components by driving an application program stored in the memory 26 to provide appropriate information to the user or process a function. Furthermore, the control unit 27 may operate at least two or more of the components included in the electronic device 20 in combination to drive the application program.

In addition, the control unit 27 may detect the movement of the electronic device 20 or the user by using a gyroscope sensor, a gravity sensor, a motion sensor, and the like included in the sensing unit 23. Alternatively, the control unit 27 may detect an object approaching the electronic device 20 or the user by using a proximity sensor, an illumination sensor, a magnetic sensor, an infrared sensor, an ultrasonic sensor, a light sensor, or the like included in the sensing unit 23. In addition, the control unit 27 may detect the user's movements through sensors provided in a controller that operates in conjunction with the electronic device 20.

Additionally, the control unit 27 may perform the operations (or functions) of the electronic device 20 using the application program stored in the memory 26.

The power supply unit 28 may receive external power or internal power under the control of the control unit 27 and supply power to each of the components included in the electronic device 20. The power supply unit 28 may include a battery, and a battery may be provided in a built-in or replaceable form.

At least some of the above components may cooperate with each other to implement the operation, control, or control method of the electronic device according to various embodiments described below. Additionally, the operation, control, or control method of the electronic device may be implemented on the electronic device by driving at least one application program stored in the memory 26.

Hereinafter, the electronic device described as one example of the present invention will be described based on an embodiment applied to a head mounted display (HMD). However, embodiments of the electronic device according to the present invention may include a mobile phone, a smart phone, a laptop computer, a digital broadcasting terminal, a personal digital assistant (PDA), a portable multimedia player (PMP), a navigation device, a slate PC, a tablet PC, an ultrabook, a wearable device, and the like. In addition to the HMD, the wearable device may include a watch-type terminal (smart watch), a contact lens, VR/AR/MR glasses, and the like.

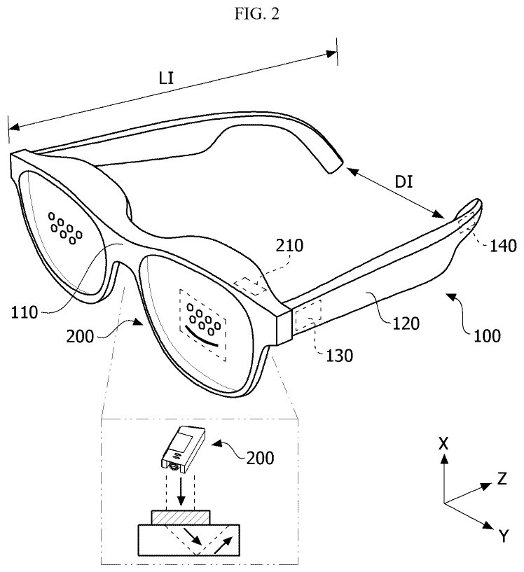

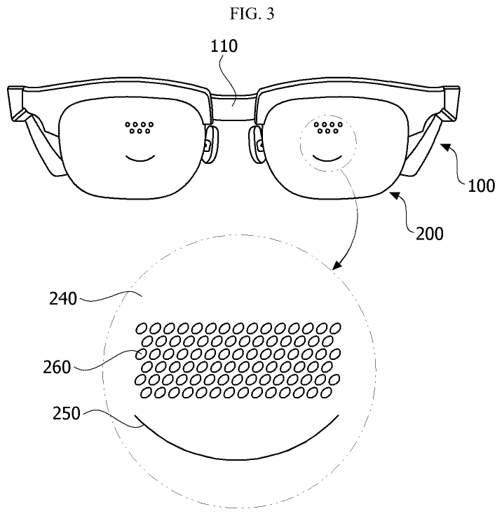

FIG. 2 is a schematic perspective view of an augmented reality electronic device according to the embodiment of the present invention, and FIG. 3 is a schematic front view of the augmented reality electronic device according to the embodiment of the present invention.

Referring to FIGS. 2 and 3, the electronic device according to the embodiment of the present invention may include a frame 100 and an optical device 200.

The electronic device may be provided in the form of glasses (smart glasses). The glasses-type electronic device is formed to be worn on the head of the human body and may include the frame 100 (case, housing, etc.) for this purpose. The frame 100 may be formed of a flexible material for easy wearing.

The frame 100 may be supported on the head and may provide a space for mounting various parts. As illustrated in the drawings, electronic components such as the optical device 200, a user input unit 130, or an audio output unit 140 may be mounted on the frame 100. Additionally, a lens covering at least one of the left and right eyes may be detachably mounted on the frame 100.

The frame 100 may have a form of glasses worn on the face of the user's body as shown in the drawings, but is not necessarily limited thereto, and may also have a form such as goggles worn in close contact with the user's face.

The frame 100 may include a front frame 110 having at least one opening, and a pair of side frames 120 that extend in an y-direction (see FIG. 2) intersecting the front frame 110 and are parallel to each other.

The frame 100 may have a length DI in an x-direction and a length LI in the y-direction, which may be the same or different.

The optical device 200 may be provided to control various electronic components provided in the electronic device. The optical device 200 may be used interchangeably with an ‘optical output device,’ an ‘image output unit,’ a ‘virtual image output unit,’ an ‘image output device,’ a ‘display device,’ etc.

The optical device 200 may generate an image or a sequence of images that are displayed to the user. The optical device 200 may include an image source panel that generates an image and a plurality of lenses or the like that diffuse and converge light generated from the image source panel.

The optical device 200 may be fixed to any one of two side frames 120. For example, the optical device 200 may be fixed to the inner side or outer side of any one of the side frames 120 or may be integrally formed by being built into any one of the side frames 120. Alternatively, the optical device 200 may be fixed to a front frame 110 or provided separately from the electronic device.

The display unit 300 may be implemented in the form of a head mounted display (HMD). The HMD form is a display that is mounted on the head and shows an image directly in front of the user's eyes. When the user wears the electronic device, the display unit 300 may be disposed to correspond to at least one of the left and right eyes so that an image is directly provided in front of the user's eyes. The optical device 200 may be disposed, for example, on both the right eye and the left eye.

The optical device 200 may allow the user to visually perceive the external environment while simultaneously allowing the user to view an image generated by the optical device 200. For example, the optical device 200 may project an image onto a display region (for example, an eye box) using a prism or the like.

Further, the optical device 200 may be formed to be transparent so that the projected image and the general field of view in front (the range that the user sees through his eyes) may be seen simultaneously. For example, in the optical device 200, particularly the optical member described below may be translucent and may be formed of a member including glass. For example, the optical device 200 may be a light guide device or may include an optical guide device.

Further, the optical device 200 may be inserted into and fixed in an opening included in the front frame 110 or may be fixed to the front frame 110 by being located on a rear surface of the opening (that is, between the opening and the user). Although the drawing illustrates an example where the optical device 200 is located on the rear surface of the opening and fixed to the front frame 110, the optical device 200 may be disposed and fixed at various locations on the frame 100.

As shown in FIGS. 2 and 3, when the electronic device causes emission light for an image from an optical device 200 to enter the optical member of the optical device 200, the emission light for the image is emitted to the other side through the optical device 200, thereby allowing the user to see the image generated by the optical device 200.

Accordingly, the user may see the external environment through the opening of the frame 100 and simultaneously see the image generated by the optical device 200. That is, the image output through the optical device 200 may appear to overlap the general field of view. The electronic device may use these display characteristics to provide augmented reality (AR), which superimposes virtual images on real-world images or backgrounds to create a single image.

Furthermore, in addition to the above operation, images generated from the external environment and the optical device 200 may be provided to the user with a time difference for a short period of time that is not recognized by a person. For example, in one frame, an external environment may be provided to the person in one section, and in another section, an image from the optical device 200 may be provided to the person. Alternatively, both the overlap and the time difference may be provided.

In addition, the optical device according to the embodiment may have a structure described below or may be formed of a structure further including a waveguide or/and glass in the structure. Additionally, the optical device may include a digital light processing (DLP) projector or the like.

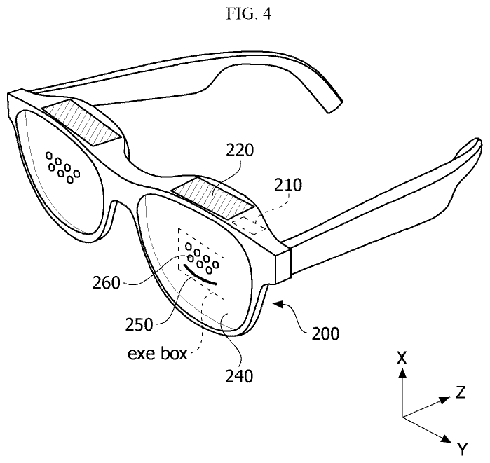

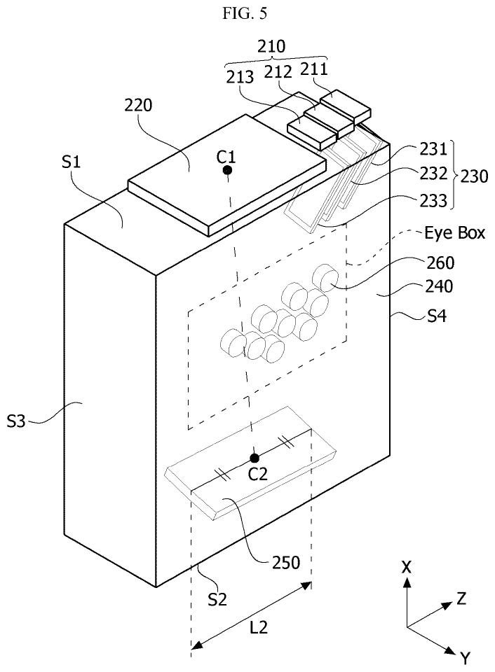

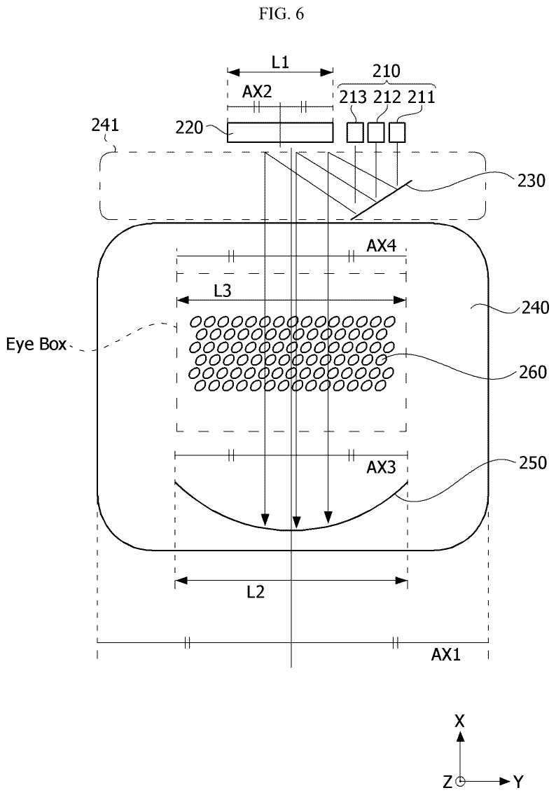

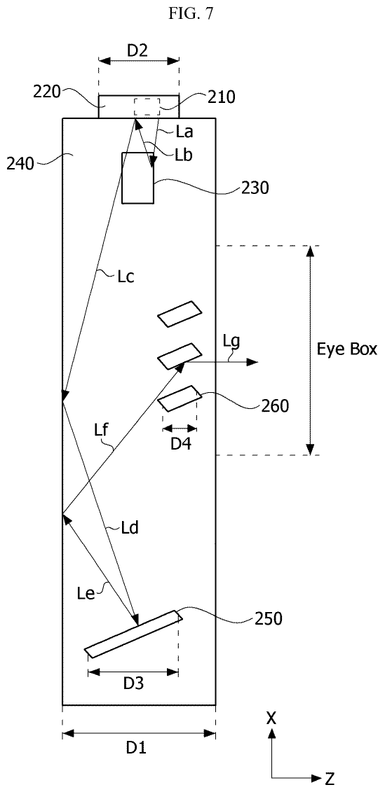

FIG. 4 is a perspective view of the electronic device including the optical device according to a first embodiment, FIG. 5 is a perspective view of the optical device according to the first embodiment, FIG. 6 is a front view of the optical device according to the first embodiment, and FIG. 7 is a side view of the optical device according to the first embodiment.

Referring to FIGS. 4 and 5, the electronic device including the optical device according to the first embodiment may include the frame 100 and the optical device 200 as described above.

Further, the optical device 200 according to the first embodiment includes a light source unit 210, an optical modulator 220, a reflective member 230, an optical member 240, a first optical element 250, and a second optical element 260. The optical device 200 may include a glass display unit and correspond to the optical member 240.

More specifically, the light source unit 210 may include at least one light source. The light source may emit light in wavelength band for at least one color to one panel.

In an embodiment, the light source unit 210 may be disposed adjacent to the optical member 240. The light source unit 210 may be disposed on the optical member 240. The light source unit 210 may be disposed on a first surface S1, which is an upper surface of the optical member 240.

Further, the light source unit 210 may include a first light source 211, a second light source 212, and a third light source 213. The first light source 211, the second light source 212, and the third light source 213 may be disposed parallel to each other on the upper surface of the optical member 240 in the optical device 200 or may be disposed spaced apart from each other.

Further, the first light source 211, the second light source 212, and the third light source 213 may emit light in different wavelength bands or light of different colors. Any one of the first light source 211, the second light source 212, and the third light source 213 may emit light in a different wavelength band. Any one of the first light source 211, the second light source 212, and the third light source 213 may emit at least one of red, green, and blue light. Further, another one of the first light source 211, the second light source 212, and the third light source 213 may emit another of red, green, and blue light. Further, another one of the first light source 211, the second light source 212, and the third light source 213 may emit another of red, green, and blue light.

For example, a wavelength of red light may be a center wavelength emitted from the first light source 211. Further, the second light source 212 may emit green light. Further, the third light source 213 may emit blue light.

Additionally, in the electronic device according to the embodiment, a first direction may correspond to an ‘X-axis direction’ in the drawings. The first direction may be a direction from the first optical element 250 toward the optical modulator 220 or the second optical element 260. Alternatively, the first direction may be a direction perpendicular to directions directed toward each other between adjacent side frames on a plane perpendicular to the direction in which an image is provided to the user (for example, the left eye or right eye) through the second optical element 260 in the optical member, which is glass. That is, when the user wears the electronic device, the first direction may correspond to a direction from a lower portion (for example, chin) to an upper portion (for example, head) with respect to the user.

Furthermore, a second direction may correspond to a Y-axis direction in the drawings. The second direction may be a direction perpendicular to the first direction. For example, the second direction may correspond to one of directions facing each other in the side frames. Further, a third direction may be a direction perpendicular to the first and second directions. Further, the third direction may correspond to a ‘Z-axis direction’ in the drawings. The third direction may correspond to the direction in which an image is provided from the optical member of the optical device 200 in the electronic device toward a person.

In addition, as described above, each of the light sources in the light source unit 210 may have a form that emits light in a plurality of wavelength bands to one panel, such as 3 (color) in 1 (number of panels), 2 in 1.

Additionally, a light emission direction of each of the first light source 211, the second light source 212, and the third light source 213 may or may not be parallel to each other. In the light source unit 210, the first light source 211, the second light source 212, and the third light source 213 may emit light in different directions. Additionally, the directions of light emitted by the first light source 211, the second light source 212, and the third light source 213 in the light source unit 210 may be parallel to each other.

The optical modulator 220 may be disposed on the optical member 240. The optical modulator 220 may be disposed adjacent to the light source unit 210. The optical modulator 220 may be disposed apart from the light source unit 210. For example, the optical modulator 220 may overlap the light source unit 210 in the second direction (Y-axis direction) on the optical member 240.

The optical modulator 220 along the optical path may be located at a rear end of the light source unit 210. Light emitted from the light source unit 210 may be incident on the optical modulator 220. Further, the optical modulator 220 may project an image by reflecting the incident light. For example, the optical modulator 220 may emit or project an image or video based on an image signal input through a board or the like. That is, the optical modulator 220 may modulate light emitted from the light source unit.

The optical modulator 220 according to the embodiment may include a digital micromirror device (DMD). Accordingly, the optical modulator 220 may include a plurality of small mirrors. Additionally, the optical modulator 220 may include various devices for displaying virtual images. For example, the optical modulator 220 may include a display device such as LCoS.

The reflective member 230 may reflect light emitted from the light source unit 210 to the optical modulator 220. The reflective member 230 may be located between the light source unit 210 and the optical modulator 220 on the optical path. In an embodiment, the reflective member 230 may be located below the light source unit 210. Further, the reflective member 230 may be tilted at a predetermined angle or have an inclined surface to reflect light emitted from the light source unit 210 to the optical modulator 220. The reflective member 230 may overlap the light source unit 210 in the first direction (X-axis direction). Further, the reflective member 230 may not overlap the optical modulator 220 in the first direction (X-axis direction). With this configuration, the blocking of light emitted from the optical modulator 220 can be prevented.

The reflective member 230 may be composed of elements having various reflective functions, such as a mirror or a prism. For example, the reflective member 230 may include a dichroic mirror.

Light for a real object, which is image light emitted from a real object, may be transmitted through the optical member 240. In addition, at the same time, the optical member 240 may perform a function of emitting light of a virtual image modulated by the optical modulator 220 to the user. For this purpose, the first optical element 250 and the second optical element 260 may be located in the optical member 240. For example, the first optical element 250 and the second optical element 260 may be embedded in the optical member 240.

The optical member 240 may correspond to, for example, a lens of glasses. Accordingly, the optical member 240 may be made of a transparent material like a lens. Further, the optical member 240 may be fixed or coupled by the above-described frame. Furthermore, other optical elements, such as a collimator, may be further disposed in the optical member 240.

Further, the optical member 240 according to the embodiment may include a plurality of surfaces. For example, the optical member 240 may include the first surface S1, a second surface S2, a third surface S3, and a fourth surface S4. The first surface S1 and the second surface S2 may be opposing surfaces in the optical member 240. The third surface S3 and the fourth surface S4 may be opposing surfaces in the optical member 240. The first surface S1 and the second surface S2 may correspond to upper and lower surfaces based on a front surface. Furthermore, light (light of a virtual image) modulated by the optical modulator 220 may be incident through the first surface S1 (or the third surface). Accordingly, the first surface S1 may correspond to an incident surface for light of the virtual image, or at least to a region from which light of the virtual image is emitted. Further, the third surface S3 and the fourth surface S4 may correspond to one surface and the other surface based on the front surface. Accordingly, the third surface S3 and the fourth surface S4 may be surfaces adjacent to a nose pad or adjacent optical member or side frame in a front frame.

The first optical element 250 may transmit the light of an image (virtual image) emitted from the optical modulator 220 to the second optical element 260. That is, the first optical element 250 may reflect the light emitted from the optical modulator 220 to the second optical element 260. In other words, the first optical element 250 may be a reflective means capable of reflecting and emitting light of an incident virtual image. However, as described below, light transmission between the components may be achieved through total reflection at an inner wall of the optical member 240 or the like.

The first optical element 250 may be disposed in the optical member 240 and located to correspond to the optical modulator 220. Further, the first optical element 250 may be located so that at least a portion thereof is offset from the second optical element 260 in the first direction (X-axis direction).

Additionally, at least a part of the first optical element 250 may be offset from the optical modulator 220 in the first direction (X-axis direction). With this configuration, the disposition space for the second optical element 260 can be easily secured.

The first optical element 250 may include a mirror or the like for reflecting light. For example, the first optical element 250 may be formed as a means such as a half mirror which partially reflects light and partially transmits light. Alternatively, the first optical element 250 may be formed of any one of a refractive optical element, a diffractive optical element (DOE), a holographic optical element (HOE), and a Fresnel mirror. Further, the first optical element 250 may be made of a material having high reflectivity, such as a metal material.

The first optical element 250 may extend in the second direction, as shown when viewed from the front, so as to become closer to the second optical element 260 toward both end portions, that is, the left and right end portions. For example, the first optical element 250 may have a curvature. Alternatively, the first optical element 250 may have one surface that is curved. For example, the first optical element 250 may have a surface (first surface) facing the second optical element 260 and an opposite surface opposite to the first surface that may be curved. Further, the first optical element 250 may be convex toward the bottom. Alternatively, the first optical element 250 may be concave toward the optical modulator 220 or the second optical element 260. Accordingly, the first optical element 250 may have a “U” shape when viewed from the front. Accordingly, the first optical element 250 may provide the function of an improved collimator.

Additionally, the first optical element 250 may include an optical element such as a notch filter that selectively transmits light according to a wavelength. Furthermore, the first optical element 250 may further include a coating layer that absorbs light on the opposite surface of the surface from which light of the virtual image is incident and emitted.

The second optical element 260 may be disposed between the optical modulator 220 and the first optical element 250 in the optical member 240. Light reflected from the first optical element 250 may be incident on the second optical element 260, and the second optical element 260 may emit the light to the user or the outside. That is, the second optical element 260 may perform a function of transmitting the light of the virtual image transmitted from the first optical element 250 toward the pupil of the user's eye.

Further, the second optical element 260 may be disposed in a matrix shape or the like when viewed from the front. With this configuration, the second optical element 260 can provide an improved viewing angle.

Additionally, light emitted (or reflected) from the first optical element 250 may be totally reflected from an inner surface of the optical member 240 into the optical member 240, and then transmitted to the second optical element 260. Accordingly, the second optical element 260 may be disposed to have an appropriate inclination angle with respect to the exit surface (for example, the surface facing the user or pupil) of the optical member 240 considering the light path. The second optical element 260 may include an optical element made of a material with high reflectivity, such as a metal material, because the second optical element 260 re-reflects the reflected light to the user or the pupil. For example, the second optical element 260 may include a mirror, a refractive element, a diffractive element, or the like. Furthermore, although the second optical element 260 includes a plurality of optical elements (mirrors, prisms, or the like), the second optical element 260 described herein is referred to collectively as the entire plurality of optical elements.

Further, the second optical element 260 may be formed to have a smaller size than the human pupil, for example, several millimeters or less, so as to deepen the depth and obtain a pinhole effect. That is, the depth of field for light incident on the pupil through the second optical element may be increased almost to infinity. In other words, the depth may be made very deep. Further, here, the depth of field refers to a range that is perceived as being in focus, and as the depth of field increases, a focal length for the image or video for augmented reality may also increase. Accordingly, even when the user changes the focal length relative to the real world while looking at the real world, the focus of the image for augmented reality may always be perceived as correct. Furthermore, the second optical element 260 may have various shapes to obtain a pinhole effect. For example, the second optical element 260 may include a ‘hole’ or a ‘groove.’

Further, the second optical element 260 may correspond to an eye box. That is, the second optical element 260 may be located in the eye box. Here, the eye box may mean a region where the image is visible when the pupil is positioned.

Referring further to FIGS. 6 and 7, each component of the optical device may overlap or may be offset from other components along various directions.

Specifically, the optical member 240 may overlap the optical modulator 220 in the first direction (X-axis direction). Accordingly, the light of the virtual image emitted from the optical modulator 220 may not be lost to the outside.

In addition, the optical modulator 220 may be disposed on the upper surface S1 of the optical member 240 and overlap the light source unit 210 including at least one light source in the second direction (Y-axis direction). In this case, the light source unit 210 may overlap the optical member 240 in the first direction (X-axis direction). Accordingly, the miniaturization of the optical device may be achieved.

Similarly, at least a part of the light source unit 210 may overlap the optical member 240 in the first direction.

Additionally, at least a part of the optical modulator 220 may overlap the first optical element 250 in the first direction (X-axis direction). With this configuration, the light of the virtual image emitted from the optical modulator 220 can be easily provided to the first optical element 250 while reducing a length of the optical member 240 in the third direction.

In particular, a center C1 of the optical modulator 220 may correspond to a center C2 of the first optical element 250. Particularly, the center C1 of the optical modulator 220 may correspond to a center (including C2) in the second direction. Additionally, the center C1 of the optical modulator 220 may correspond to a center of the eye box or the second optical element 260. For example, the center C1 of the optical modulator 220 may be located within 0.2 times a length in the second direction (Y-axis direction) from the center (including C2) of the first optical element 250 in the second direction (Y-axis direction). With this configuration, the optical device and the electronic device according to the embodiment can provide improved optical efficiency. Furthermore, the miniaturization of the optical device and the electronic device may also be easily implemented.

Further, at least a part of the second optical element 260 may be offset from the first optical element 250 in the first direction (X-axis direction). Particularly, the second optical element 260 may be disposed adjacent to an emission surface of the optical member 240. Furthermore, the first optical element 250 may be located closer to an opposite surface compared to the emission surface. Additionally, reflection may occur on the opposite surface in the optical member 240 along the above-described optical path. Accordingly, the miniaturization of the optical member 240 may be easily achieved.

Additionally, a center of at least one of the second optical element 260, the first optical element 250, and the optical modulator 220 may be disposed to corresponds to or to be misaligned with a center of the optical member 240.

For example, the optical member 240 may have a first axis AX1 (or surface) that bisects the optical member 240 in the second direction (Y-axis direction). Further, the optical modulator 220 may have a second axis AX2 (or surface) that bisects the optical modulator 220 in the second direction (Y-axis direction). The first optical element 250 may have a third axis AX3 (or surface) that bisects the first optical element 250 in the second direction (Y-axis direction). The second optical element 260 may have a fourth axis AX4 (or surface) that bisects the second optical element 260 in the second direction (Y-axis direction). The first axis AX1 (or surface) may correspond to the second axis AX2, the third axis AX3, and the fourth axis AX4. This configuration may facilitate manufacturing and improve structural reliability.

Additionally, the first axis AX1 (or surface) may be disposed spaced apart from at least one of the second axis AX2, the third axis AX3, and the fourth axis AX4. With this configuration, the light of the virtual image can be provided in a desired eye box location or customized for the user.

Further, a length L1 of the optical modulator 220 in the second direction (Y-axis direction) may be less than or equal to a length L3 of the second optical element 260 (or eye box) in the second direction or a length L2 of the first optical element 250 in the second direction. That is, the length L1 of the optical modulator 220 in the second direction (Y-axis direction) may be less than or equal to the length L3 of the second optical element 260 in the second direction or the length L2 of the first optical element 250 in the second direction. Accordingly, the miniaturization of the optical device may be easily implemented, and the collimation of light may be easily achieved, thereby improving optical performance.

Furthermore, the first optical element 250 and the second optical element 260 may have corresponding lengths in the second direction (Y-axis direction). For example, the length L2 of the first optical element 250 in the second direction (Y-axis direction) may have a range within 20% of the length L3 of the second optical element 260 in the second direction (Y-axis direction). Accordingly, the first optical element 250 may be formed so that a length in a horizontal direction when viewed from the front corresponds to the length of the second optical element 260 in the horizontal direction. Thus, the first optical element 250 may perform a function as a more improved collimator.

In addition, the length of the first optical element 250 in the third direction (Z-axis direction) may be formed within an appropriate range by considering factors such as a ghost image, an optical path, optical performance, and a form factor. Here, the length of the first optical element 250 in the third direction (Z-axis direction) means a length between both ends of the first optical element 250.

In an embodiment, a length D1 of the optical member 240 in the third direction (Z-axis direction) may be greater than a length D3 of the first optical element 250 in the third direction (Z-axis direction). With this configuration, the optical device can provide improved optical performance.

Further, a length D2 of the optical modulator 220 in the third direction (Z-axis direction) may be greater than the length D3 of the first optical element 250 in the third direction (Z-axis direction). Accordingly, light loss may be minimized.

The length D1 of the optical member 240 in the third direction (Z-axis direction) may be greater than the length D2 of the optical modulator 220 in the third direction. Accordingly, the optical device may provide improved optical performance.

Additionally, as described above, the second optical element 260 may be offset from the first optical element 250 in the first direction (X-axis direction). Additionally, at least a part of the optical modulator 220 may overlap the first optical element 250 and the second optical element 260 in the first direction (X-axis direction). Furthermore, the light source unit 210 may partially overlap the first optical element 250 in the first direction (X-axis direction). However, the light source unit 210 may overlap or may be offset from the second optical element 260 in the first direction (X-axis direction). With this configuration, a gap between components in the optical member 240 can be reduced to minimize the length of the optical member 240 in the third direction, while easily providing the light of the virtual image to the user.

Additionally, the electronic device or the optical device according to the embodiment may include a mirror or a prism, which is a reflective member, as a component to provide improved optical efficiency.

Further, in the electronic device according to the embodiment, the optical device 200 includes an ‘image emission unit,’ and the image emission unit may include the light source unit 210, the optical modulator 220, and the reflective member 230. Further, the light emitted from the image emission unit may be provided to the user through reflection or the like in the optical member 240.

More specifically, the optical path in the optical device 200 will be described below. First, light of the virtual image emitted from the image emission unit may be transmitted to the first optical element 250 embedded and disposed in the inside of the optical member 240 (Lb). In this case, light emitted from the light source unit 210 may be reflected from the reflective member 230 and provided to the optical modulator 220 (La).

Further, the light of the virtual image emitted from the image emission unit may travel toward the inner surface of the optical member 240 (Lc) and may be reflected (for example, total reflection) from the inner surface and transmitted to the first optical element 250 (Ld). This enables the miniaturization of the optical device.

However, this is an example, and as described above, the light of the virtual image emitted from the image emission unit may be directly transmitted to the first optical element 250 without going through total reflection on the inner surface of the optical member 240. In this case, the optical device may provide improved optical performance.

Furthermore, may be reflected at least once from at least one of a plurality of surfaces of the optical member 240 and transmitted to the first optical element.

Additionally, the image emission unit may further include an optical element including a combination of at least one of a reflective means, a refractive means, and a diffractive means. In this case, the optical element may reflect, refract, or diffract light emitted from a light source or an optical modulator and transmit the light to the first optical element 250 of the optical member 240. For example, an optical element which guides light or transmits light may be further disposed between the optical modulator 220 and the optical member 240. Furthermore, the optical member 240 may further include an additional reflective member (for example, a mirror) located to correspond to a region where light emitted from the optical modulator is reflected. The additional reflective member may be disposed inside or outside the optical member 240.

Further, light Le may be reflected from the first optical element 250 and reflected to an inner wall surface of the optical member 240. Further, light Lf reflected from the inner wall surface may be transmitted to the second optical element 260. Further, the second optical element 260 may project light Lg to the user (or right eye/left eye or the like) by a pinhole effect or the like.

In addition, although the image emission unit is shown as being disposed on the upper surface of the optical member 240, this is an example and it is clear that the image emission unit may be disposed in other locations. For example, the image emission unit may be disposed on a lower surface of the optical member 240.

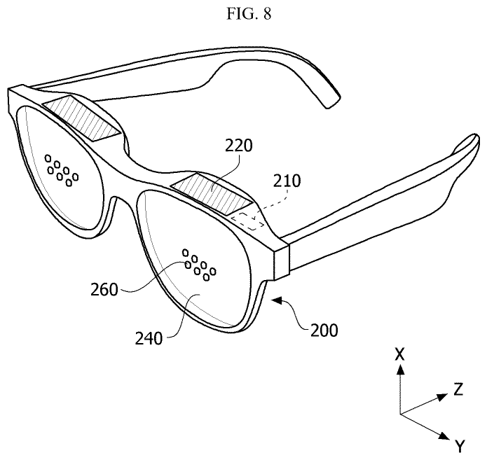

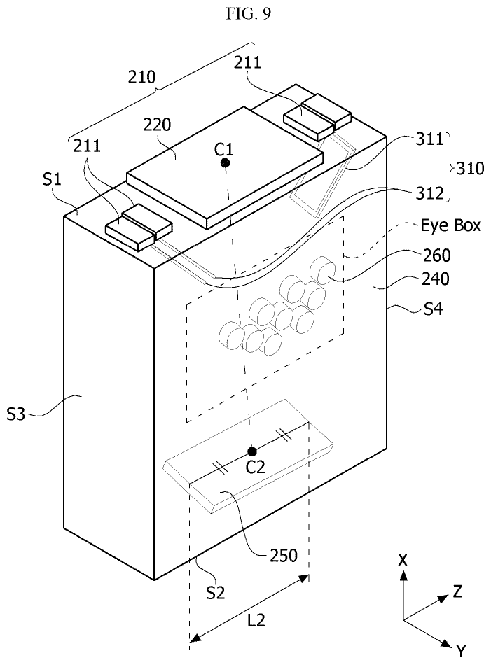

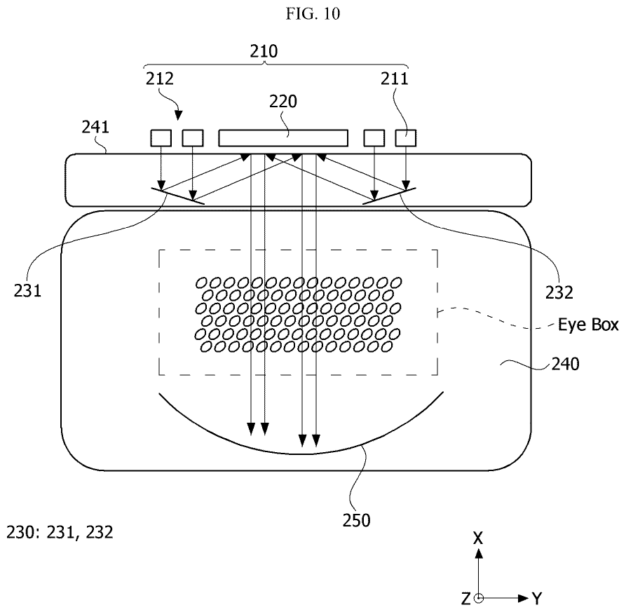

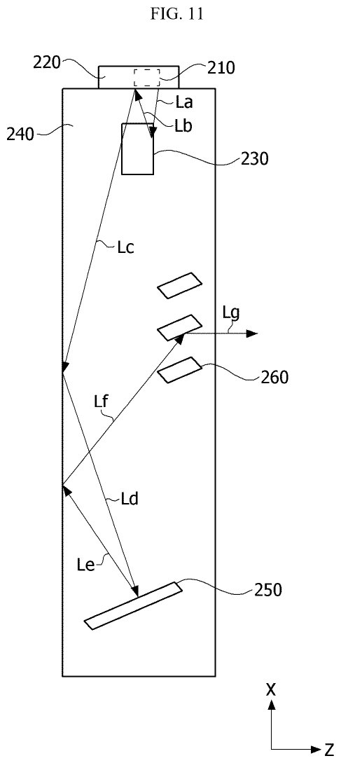

FIG. 8 is a perspective view of an electronic device including an optical device according to a second embodiment, FIG. 9 is a perspective view of the optical device according to the second embodiment, FIG. 10 is a front view of the optical device according to the second embodiment, and FIG. 11 is a side view of the optical device according to the second embodiment.

Referring to FIGS. 8 to 11, the electronic device including the optical device according to the second embodiment may include a frame 100 and an optical device 200 as described above. Further, the optical device 200 according to the second embodiment may include a light source unit 210, an optical modulator 220, a reflective member 230, an optical member 240, a first optical element 250, and a second optical element 260. Further, except for the contents described below, the contents described in various embodiments can be applied to this embodiment.

The light source unit 210 may include at least one light source. The light source may emit light in one wavelength band for at least one color to one panel.

The light source unit 210 may include a first light source unit 211 and a second light source unit 212. The first light source unit 211 and the second light source unit 212 are disposed parallel to each other on an upper surface of the optical member 240 in the optical device 200 and may be disposed spaced apart from each other. The first light source unit 211 and the second light source unit 212 may emit light in different wavelength bands. For example, the first light source unit 211 may emit red and blue light, and the second light source unit 212 may emit green light.

Further, the optical modulator 220 may be disposed between a plurality of light sources. With this configuration, the optical modulator 220 may be located to correspond to or adjacent to a first axis AX1, which is a bisector in the center or second direction of the optical device 200. Furthermore, at least a part of the optical modulator 220 may overlap the first optical element 250 in the first direction (X-axis direction). Further, a third axis AX3 of the first optical element 250 may be located within 10% of the length L2 of the first optical element 250 in the second direction based on a second axis AX2. With this configuration, the position of the eye box or the position of the optical modulator 220 in the optical member 240 can be set to be adjacent to the center. Therefore, the structural reliability of the optical device can be improved or the ease of design can be easily secured.

The reflective member 230 may reflect light emitted from the light source unit 210 to the optical modulator 220. The reflective member 230 may be located between the light source unit 210 and the optical modulator 220 on the optical path. In an embodiment, the reflective member 230 may be located below the light source unit 210. Further, the reflective member 230 may be tilted at a predetermined angle or have an inclined surface to reflect light emitted from the light source unit 210 to the optical modulator 220. The reflective member 230 may overlap the light source unit 210 in the first direction (X-axis direction).

The reflective member 230 may be located to correspond to the light source unit 210. For example, the reflective member 230 may include a first reflector 231 and a second reflector 232. The first reflector 231 may be located below the first light source unit 211. The first reflector 231 may be located to overlap the first light source unit 211 in the first direction. The second reflector 232 may be located below the second light source unit 212. The second reflector 232 may be located to overlap the second light source unit 212 in the first direction.

Accordingly, at least a part of the first reflector 231 and the second reflector 232 may overlap the first optical element 250 in the first direction. Further, at least a part of the first reflector 231 and the second reflector 232 may not overlap the second optical element 260 in the first direction.

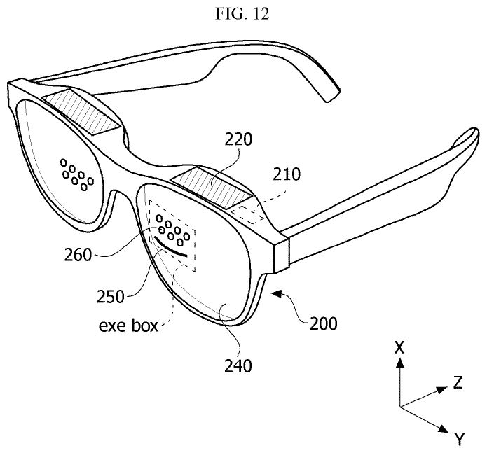

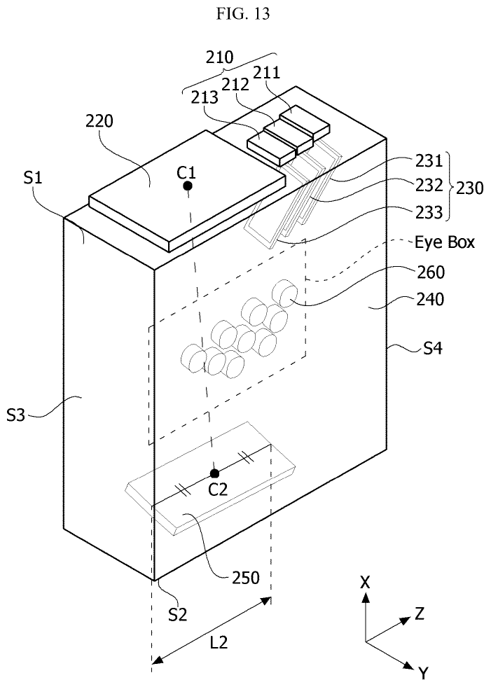

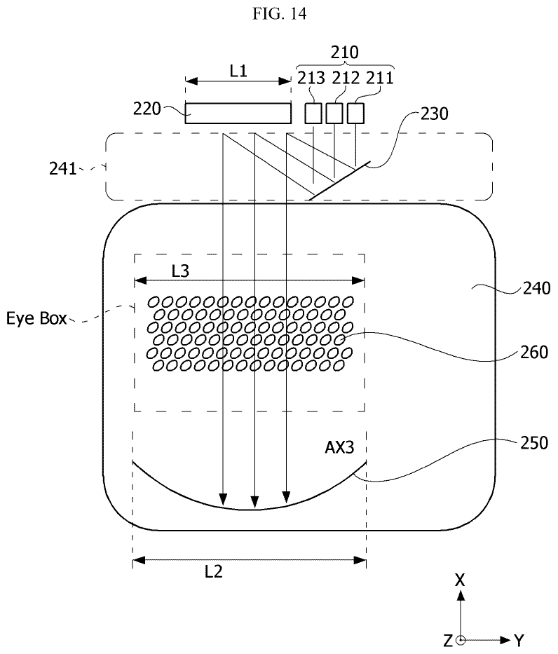

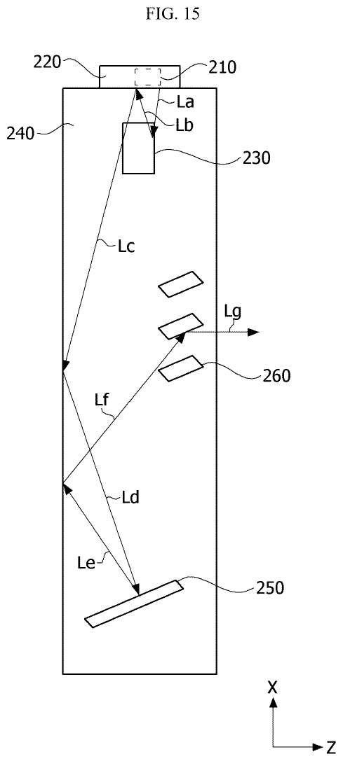

FIG. 12 is a perspective view of an electronic device including an optical device according to a third embodiment, FIG. 13 is a perspective view of the optical device according to the third embodiment, FIG. 14 is a front view of the optical device according to the third embodiment, and FIG. 15 is a side view of the optical device according to the third embodiment.

Referring to FIGS. 12 to 15, the electronic device including the optical device according to the third embodiment may include a frame 100 and an optical device 200 as described above. Further, the optical device 200 according to the third embodiment includes a light source unit 210, an optical modulator 220, a reflective member 230, an optical member 240, a first optical element 250, and a second optical element 260. Further, except for the contents described below, the contents described in various embodiments can be applied to this embodiment.

Likewise, the light source unit 210 may include at least one light source. The light source may emit light in one wavelength band for at least one color to one panel.

In this case, in the optical device 200, at least one of the light source unit 210, the optical modulator 220, the reflective member 230, the first optical element 250, and the second optical element 260 may be located closer to one surface of the optical member 240 than to the other surface. Here, one surface of the optical member 240 may be a surface adjacent to an adjacent optical member in the electronic device. For example, one side of the optical member 240 may be a surface facing the center of the nose pad or the front frame.

For example, the first optical element 250 and the second optical element 260 may be disposed closer to one surface of the optical member 240 than to the other surface to provide an effective eye box. That is, the eye box may be located anisotropically close to the user's (person's) eyes.

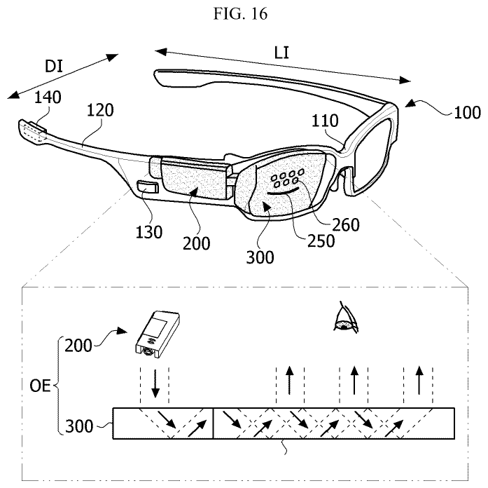

FIG. 16 is a schematic perspective view of an augmented reality electronic device according to another embodiment of the present invention.

As illustrated in FIG. 16, the electronic device according to another embodiment of the present invention may include a frame 100, a projection device 200, and a display unit 300. A detailed description of this will be made below.

Except for the matters described below, the above contents may be applied equally.

Electronic components such as the projection device 200, a user input unit 130, or an audio output unit 140 may be mounted on the frame 100. Additionally, a lens covering at least one of the left and right eyes may be detachably mounted on the frame 100.

The frame 100 may have a form of glasses worn on the face of the user's body as shown in the drawing, but is not necessarily limited thereto, and may also have a form such as goggles worn in close contact with the user's face.

The frame 100 may include a front frame 110 having at least one opening, and a pair of side frames 120 that extend in the y direction (see FIG. 16) intersecting the front frame 110 and are parallel to each other.

The frame 100 may have a length DI in the x direction and length LI in the y direction, which are the same or different.

The projection device 200 may be provided to control various electronic components provided in the electronic device. The projector 200 may be used interchangeably with an ‘optical output device,’ an ‘optical projector,’ a ‘light irradiation device,’ an ‘optical device,’ a ‘projector,’ etc.

The projection device 200 may generate an image or a video including a series of images that is displayed to the user. The projection device 200 may include an image source panel that generates an image, a plurality of lenses that diffuse and converge light generated from the image source panel, and the like.

The projection device 200 may be fixed to one side frame 120 of the two side frames 120. For example, the projection device 200 may be fixed to the inner side or outer side of the one side frame 120 or integrally formed by being built into the one side frame 120. Alternatively, the projector 200 may be fixed to the front frame 110 or provided separately from the electronic device.

The display unit 300 may be implemented in the form of a head mounted display (HMD). The HMD form refers to a display that is mounted on the head and shows an image directly in front of the user's eyes. When the user wears the electronic device, the display unit 300 may be disposed to correspond to at least one of the left and right eyes so that an image is directly provided in front of the user's eyes. The drawing illustrates the display unit 300 located in a portion corresponding to the user's right eye so that an image is output toward the right eye. However, as described above, the present invention is not limited thereto and the display unit 300 may be disposed on both the left and right eyes.

The display unit 300 may allow the user to visually perceive the external environment while simultaneously displaying an image generated by the projection device 200 to the user. For example, the display unit 300 may project an image onto a display region using a prism.

Further, the display unit 300 may be formed to be transparent so that the projected image and the general field of view in front (the range that the user sees through his/her eyes) can be viewed simultaneously. For example, the display unit 300 may be translucent and may be formed of an optical member including glass. For example, the display unit 300 may be a light guide device or may include a light guide device.

Further, the display unit 300 may be inserted into and fixed in an opening included in the front frame 110 or may be located on the back surface of the opening (that is, between the opening and the user) and fixed to the front frame 110. Although the drawing illustrates, as one example, a case in which the display unit 300 is located on the back surface of the opening and fixed to the front frame 110, in contrast, the display unit 300 may be located and fixed at various locations on the frame 100.

As illustrated in FIG. 16, when the electronic device causes emission light for an image from the projection device 200 to be incident on one side of the display unit 300, the emission light for the image is emitted to the other side through the display unit 300, thereby allowing the user to view the image generated from the projection device 200.

Accordingly, the user may view the external environment through the opening of the frame 100 and simultaneously view the image generated by the projection device 200. That is, the image output through the display unit 300 may appear to overlap the general field of view. The electronic device may use these display characteristics to provide augmented reality (AR), which superimposes virtual images on real-world images or backgrounds to create a single image.

Furthermore, in addition to the above operation, images generated from the external environment and the projection device 200 may be provided to the user with a time difference for a short period of time that is not recognized by the person. For example, in one frame, an external environment may be provided to a person in one section, and in another section, an image from the projection device 200 may be provided to the person.

Alternatively, both the overlap and the time difference may be provided.

In addition, the projection device according to the embodiment may have a structure described below or may be formed of a structure further including a waveguide or/and glass in the structure. Additionally, the projection device may include a digital light processing (DLP) projector or a projection device.

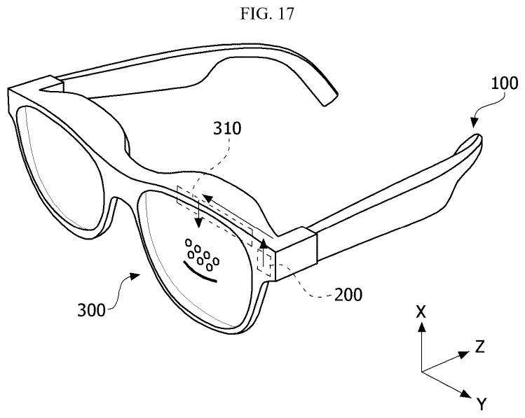

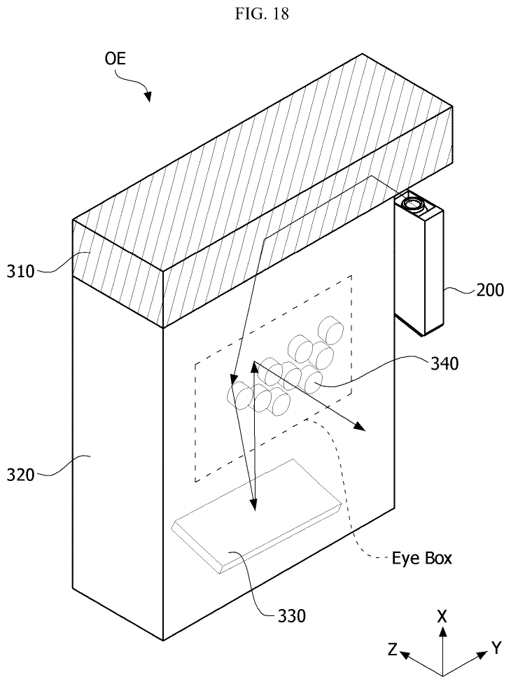

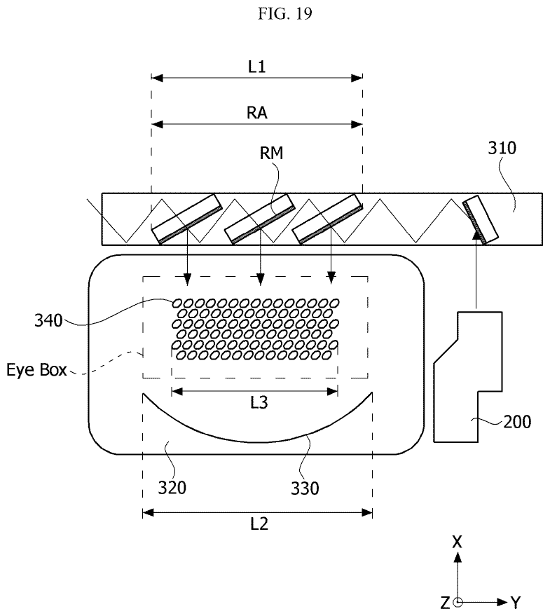

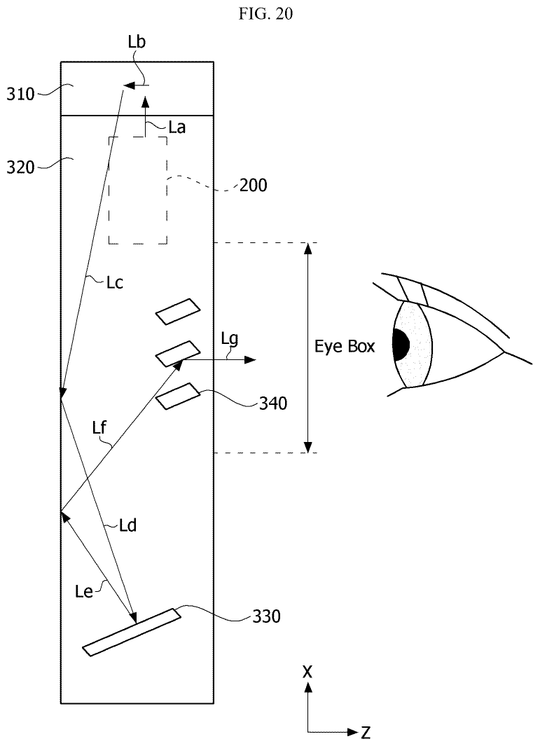

FIG. 17 is a perspective view of an electronic device including an optical device according to a fourth embodiment, FIG. 18 is a perspective view of the optical device according to the fourth embodiment, FIG. 19 is a front view of the optical device according to the fourth embodiment, and FIG. 20 is a side view of the optical device according to the fourth embodiment.

Referring to FIGS. 17 to 20, the electronic device including the optical device according to the fourth embodiment may include a frame 100 and an optical device OE. Additionally, the electronic device may include the frame 100, a projector 200, and a display unit 300. For example, the optical device OE may include the projector 200 and the display unit 300.

More specifically, the optical device OE according to the fourth embodiment includes the projector 200, a guide unit 310, an optical member 320, a first optical element 330, and a second optical element 340.

The projector 200 may emit or project a virtual image or the like by reflecting illumination light generated from a light source based on an image signal. Accordingly, the projector 200 may include a light source that outputs light and an optical modulator that modulates the light into a virtual image. For example, the light source may include a light source that emits light of a plurality of colors. The optical modulator may include a DMD. The optical modulator may also include various devices for displaying virtual images. For example, the optical modulator may include a display device such as LCoS.

The projector 200 may be disposed adjacent to the guide unit 310 and the optical member 320 described below. Further, the projector 200 may have its emission surface facing the guide unit 310. That is, the emission surface of the projector 200 may face the guide unit 310. The light of an image or virtual image emitted from the projector 200 may be transmitted to the guide unit 310.

Additionally, in the electronic device or the optical device according to the embodiment, the first direction may correspond to the ‘X-axis direction’ in the drawings. The first direction may be a direction from the first optical element 330 toward the guide unit 310 or the second optical element 340. Alternatively, the first direction may be a direction perpendicular to directions directed toward each other between adjacent side frames on a plane perpendicular to the direction in which an image is provided to the user (for example, the left eye or right eye) through the second optical element 340 in the optical member, which is glass. That is, when the user wears the electronic device, the first direction may correspond to a direction from the bottom (for example, chin) to the top (for example, head) with respect to the user.

Furthermore, the second direction may correspond to the Y-axis direction in the drawings. The second direction may be a direction perpendicular to the first direction. For example, the second direction may correspond to one of the directions facing each other in the side frames. Further, the third direction may be a direction perpendicular to the first and second directions. Further, the third direction may correspond to the ‘Z-axis direction’ in the drawings. The third direction may correspond to the direction in which an image is presented from the optical element of the optical device OE toward a person in the electronic device.

The guide unit 310 may be located adjacent to the optical member 320. The guide unit 310 may guide light emitted from the projector 200 along one side surface of the optical member 320. For example, the guide unit 310 may guide light by reflecting the light so that the guide unit 310 has an incident angle of about 45 degrees with respect to the light incident from the projector 200. In this case, the guide unit 310 may be guided according to a difference in refractive index (for example, thick/thin or high refractive index/low refractive index). Light guided by the guide unit 310 may be guided along a side surface of the optical member 320. For example, light guided by the guide unit 310 may be guided along an upper surface (or lower surface) of the optical member 320. Further, the guide unit 310 may include a reflection region RA that reflects the guided light toward the optical member 320 or the first optical element 330.

The guide unit 310 may be formed of a waveguide that guides light and reflects light toward the first optical element 330 or the optical member 320. For example, the guide unit 310 may include a refractive optical element, a DOE, an HOE, etc.

Further, the guide unit 310 may include a reflection region (or reflection portion). The reflection region RA of the guide unit 310 may be formed of a reflection film or a region with a different refractive index. The reflection region RA of the guide unit 310 may reflect light guided in one direction and may be located to correspond to the first optical element 330. In this example, the reflection region RA of the guide unit 310 may reflect the light guided in a direction opposite to the first direction (X-axis direction).

In an embodiment, the maximum length L1 of the reflection region RA of the guide unit 310 in the second direction (Y-axis direction) may be less than or equal to the maximum length L2 of the first optical element 330 in the second direction (Y-axis direction). With this configuration, optical efficiency can be improved through the first optical element 330. Accordingly, the performance of the electronic device can be improved and reliability can also be enhanced due to heat generation or the like.

Light for a real object, which is image light emitted from a real object may be transmitted through the optical member 320. Additionally, at the same time, the optical member 320 may perform a function of emitting light of a virtual image modulated from the projector 200 to the user. For this purpose, the first optical element 330 and the second optical element 340 may be located in the optical member 320. For example, the first optical element 330 and the second optical element 340 may be embedded in the optical member 320.

The optical member 320 may correspond to, for example, a lens of glasses. Accordingly, the optical member 320 may be made of a transparent material such as a lens. Further, the optical member 320 may be fixed or coupled by the above-described frame. Furthermore, other optical elements, such as a collimator, may be further disposed in the optical member 320.

Further, the optical member 320 according to the embodiment may be disposed adjacent to the guide unit 310. For example, the optical member 320 may be located to correspond to the reflection region RA of the guide unit 310. Particularly, the optical member 320 or the first optical element 330 may be disposed so that the first optical element 330 in the optical member 320 corresponds to the reflection region RA of the guide unit 310. Additionally, the optical member 320 may be located on a traveling path of light reflected from the reflection region RA. Accordingly, light reflected in the reflection region RA may be transmitted into the optical member 320. Further, light may be transmitted to the first optical element 330 in the optical member 320.

The first optical element 330 may transmit light of an image (virtual image) emitted from the projector 200 to the second optical element 340. That is, the first optical element 330 may reflect light emitted from the projector 200 to the second optical element 340. In other words, the first optical element 330 may be a reflective means capable of reflecting and emitting light of an incident virtual image. However, as described below, light transmission between each component may be achieved through total reflection on an inner wall of the optical member 320.

The first optical element 330 may be disposed in the optical member 320 and located to correspond to the guide unit 310. The first optical element 330 may overlap the guide unit 310 in one direction (for example, the first direction). This may provide improved optical efficiency.

The first optical element 330 may include a mirror or the like for reflecting light. For example, the first optical element 330 may be formed as a means such as a half mirror which partially reflects light and partially transmits light. Alternatively, the first optical element 330 may be formed of any one of a refractive optical element, a DOE, an HOE, and a Fresnel mirror. Further, the first optical element 330 may be made of a material having high reflectivity, such as a metal material.

In an embodiment, the first optical element 330 may extend in the second direction, as shown when viewed from the front, so as to become closer to the second optical element 340 toward both end portions, that is, the left and right end portions. For example, the first optical element 330 may extend in the second direction, and a separation distance in the first direction (X-axis direction) from the second optical element 340 at both end portions in the second direction may be smaller than a separation distance in the first direction (X-axis direction) from the second optical element 340 at a central portion.

Further, the first optical element 330 may have a curvature. Alternatively, the first optical element 330 may have one surface that is curved. For example, the first optical element 330 may have a surface (first surface) facing the second optical element 340 and an opposite surface opposite to the first surface that may be curved. Further, the first optical element 330 may be concave toward the guide unit 310. Additionally, the first optical element 330 may be concave toward the second optical element 340. Additionally, the first optical element 330 may be concave in the first direction (X-axis direction). Alternatively, the first optical element 330 may be convex in the opposite direction or downward relative to the first direction. Accordingly, the first optical element 330 may have a “U” shape when viewed from the front. Accordingly, the first optical element 330 may provide the function of an improved collimator.

Additionally, the first optical element 330 may include an optical element such as a notch filter that selectively transmits light according to a wavelength. Furthermore, the first optical element 330 may further include a coating layer that absorbs light on the opposite side of the surface from which light of the virtual image is incident and emitted.

The second optical element 340 may be disposed in the optical member 320. Additionally, the second optical element 340 may be disposed between the guide unit 310 and the first optical element 330. Light reflected from the first optical element 330 may be incident on the second optical element 340 and the second optical element 340 may emit the light to the user or the outside. That is, the second optical element 340 may perform a function of transmitting the light of the virtual image transmitted from the first optical element 330 toward the pupil of the user's eye.

Furthermore, the first optical element 330 may be located so that at least a portion thereof is offset from the second optical element 340 in the first direction (X-axis direction). Further, the maximum length L2 of the first optical element 330 in the other direction or the second direction (Y-axis direction) may be greater than the maximum length L3 of the second optical element 340 in the other direction or the second direction (Y-axis direction). For example, the maximum length L2 of the first optical element 330 in the other direction or the second direction (Y-axis direction) may be less than or equal to the length of the eye box. With this configuration, the first optical element 330 can perform a function as a more improved collimator. Further, light reflected from the first optical element 330 may be transmitted to the second optical element 340 at a high rate.

Further, the second optical elements 340 may be disposed in a matrix shape or the like when viewed from the front. With this configuration, the second optical element 340 may provide an improved viewing angle.

Additionally, light emitted (or reflected) from the first optical element 330 may be totally reflected from an inner surface of the optical member 320 into the optical member 320 and then transmitted to the second optical element 340. Accordingly, the second optical element 340 may be disposed to have an appropriate inclination angle with respect to an emission surface (for example, the surface facing the user or pupil) of the optical member 320 considering the light path. The second optical element 340 may include an optical element made of a material with high reflectivity, such as a metal, because the second optical element 340 re-reflects the reflected light to the user or the pupil. For example, the second optical element 340 may include a mirror, a refractive element, a diffractive element, etc. Furthermore, although the second optical element 340 includes a plurality of optical elements (mirrors, prisms, etc.), the second optical element 340 here may be referred to collectively as the entire plurality of optical elements.

Further, the second optical element 340 may be formed to have a smaller size than the human pupil, for example, several millimeters or less, so as to deepen the depth and obtain a pinhole effect. That is, the depth of field for light incident on the pupil through the second optical element may be increased almost to infinity. In other words, the depth may be made very deep. Further, here, depth of field may refer to a range that is perceived as being in focus, and as a depth of field increases, a focal length for the image or video for augmented reality may also increase. Accordingly, even when the user changes the focal length relative to the real world while looking at the real world, the focus of the image for augmented reality may always be perceived as correct. Furthermore, the second optical element 340 may have various shapes to obtain a pinhole effect. For example, the second optical element 340 may include a ‘pinhole,’ a ‘hole,’ or a ‘groove.’

Further, the second optical element 340 may correspond to an eye box. That is, the second optical element 340 may form an eye box. In the optical member 320, the second optical element 340 may be located in the eye box. Here, the eye box may mean a region where an image is visible when the pupil is positioned.

Further, each component of the optical device may overlap or may be offset from other components in various directions.

The reflection region RA of the guide unit 310 may overlap the first optical element 330 and the second optical element 340 in one direction. For example, at least a part of the reflection region RA of the guide unit 310 may overlap the first optical element 330 and the second optical element 340 in the first direction (X-axis direction). As a result, miniaturization and improved light efficiency may be achieved.

The guide unit 310 and the first optical element 330 may be located on a long side or a short side of the optical member 320. For example, the optical member 320 may have a first surface that is a long side in the front view or a cross section (XY plane) and a second surface corresponding to the first surface. Further, the optical member 320 may have a third surface that is a short side in the front view or a cross section (XY plane) and a fourth surface corresponding to the third surface. In this case, the guide unit 310 and the first optical element 330 may be disposed on the first surface and the second surface, respectively. For example, the guide unit 310 may be disposed adjacent to the first surface (or the second surface), and the first optical element 330 may be disposed adjacent to the second surface (or the first surface).

Additionally, at least a part of the guide unit 310 may overlap the first optical element 330 in the first direction (X-axis direction). With this configuration, the light of the virtual image reflected from the guide unit 310 can be easily provided to the first optical element 330 while reducing the length of the optical member 320 in the third direction.

Further, a center of the second optical element 340 and a center of the first optical element 330 may be disposed to be offset from a center of the optical member 320. For example, the center of the second optical element 340 and the center of the first optical element 330 may be located shifted to one side from the center of the optical member 320. The center of the second optical element 340 and the center of the first optical element 330 may move in a direction opposite to the second direction relative to the center of the optical member 320. In other words, the center of the second optical element 340 and the center of the first optical element 330 may be shifted from the center of the optical member 320 toward a center of an adjacent optical member or the front frame (for example, a nose pad). Thus, the center of the second optical element 340 and the center of the first optical element 330 may be located closer to the adjacent optical member or the front frame (for example, a nose pad) than the center of the optical member 320. With this configuration, the first optical element 330 and the second optical element 340 may be disposed closer to the nose pad or the like than the optical member 320. Accordingly, an effective eye box may be provided. In other words, the eye box may be located anisotropically close to the user's (human's) eyes.

The center of the second optical element 340 and the center of the first optical element 330 may correspond to each other. Particularly, the center of the second optical element 340 may correspond to the center in the second direction. Additionally, the center of the second optical element 340 may correspond to the center of the eye box or the second optical element 340. For example, the center of the second optical element 340 may be located within 0.2 times the length in the second direction (Y-axis direction) from the center of the first optical element 330 in the second direction (Y-axis direction). With this configuration, the optical device and the electronic device according to the embodiment can provide improved optical efficiency. Furthermore, the miniaturization of the optical device and the electronic device may also be easily implemented.

Further, at least a part of the second optical element 340 may be offset from the first optical element 330 in the first direction (X-axis direction). Particularly, the second optical element 340 may be disposed adjacent to the emission surface of the optical member 320. Furthermore, the first optical element 330 may be located closer to the opposite surface than the emission surface. Additionally, reflection may occur on the opposite surface in the optical member 320 on the above-described optical path. Accordingly, the miniaturization of the optical member 320 may be easily achieved.

Additionally, a center of at least one of the second optical element 340, the first optical element 330, and the guide unit 310 may be disposed to corresponds to or to be misaligned with the center of the optical member 320.

In addition, a length of the first optical element 330 in the third direction (Z-axis direction) may be formed within an appropriate range by considering factors such as a ghost image, an optical path, optical performance, and a form factor. Here, the length of the first optical element 330 in the third direction (Z-axis direction) means a length between both ends of the first optical element 330.

Additionally, the electronic device or the optical device according to the embodiment may include a mirror or prism, which is a reflective member, as a component to provide improved optical efficiency.

Further, in the electronic device according to the embodiment, the optical device OE may correspond to the ‘image emission unit.’ More specifically, the optical path in the optical device OE will be described below. First, the light (La) of the virtual image emitted from the projector may be guided (Lb) along the guide unit 310 and reflected (Lc) toward the optical member 320 in the reflection region RA of the guide unit 310. Further, light transmitted to the optical member 320 may be transmitted to the first optical element 330 embedded in the interior of the optical member 320. In this case, light of the virtual image reflected in the reflection region RA may travel toward the inner surface of the optical member 320, and may be reflected (for example, totally reflected) on the inner surface and transmitted to the first optical element 330 (Ld). This enables the miniaturization of the optical device.

However, this is an example, and as described above, light of the virtual image emitted from the image emission unit may be directly transmitted to the first optical element 330 without going through total reflection on the inner surface of the optical member 320. In this case, the optical device may provide improved optical performance. Furthermore, may be reflected at least once from at least one of a plurality of surfaces of the optical member 320 and transmitted to the first optical element.

Additionally, the optical device may further include an optical element including a combination of at least one of a reflective means, a refractive means, and a diffractive means. In this case, the optical element may reflect, refract, or diffract light emitted from the light source or the optical modulator and transmit the light to the first optical element 330 of the optical member 320. For example, the optical member 320 may further include an additional reflective member (for example, a mirror) located to correspond to a region where light emitted from the optical modulator is reflected. The additional reflective member may be disposed inside or outside the optical member 320.

Furthermore, light Le reflected from the first optical element 330 may be reflected to the inner wall surface of the optical member 320. Further, light Lf reflected from the inner wall surface may be transmitted to the second optical element 340. Further, the second optical element 340 may emit light Lg to the user (or right eye/left eye or the like) by a pinhole effect or the like.

In addition, although the guide unit 310 is shown as being disposed on the upper surface of the optical member 320, this is an example and it is clear that the guide unit 310 may be disposed in other locations. For example, the guide unit 310 may be disposed on a lower surface of the optical member 320.

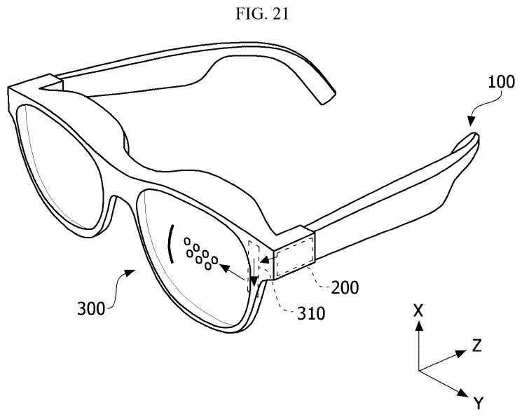

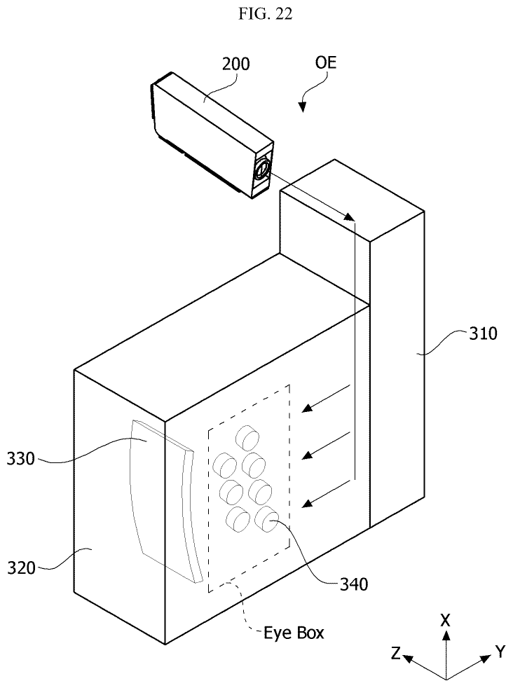

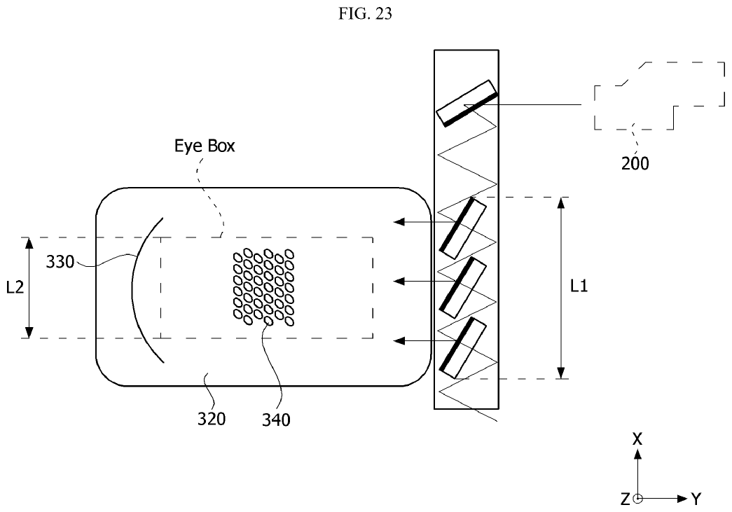

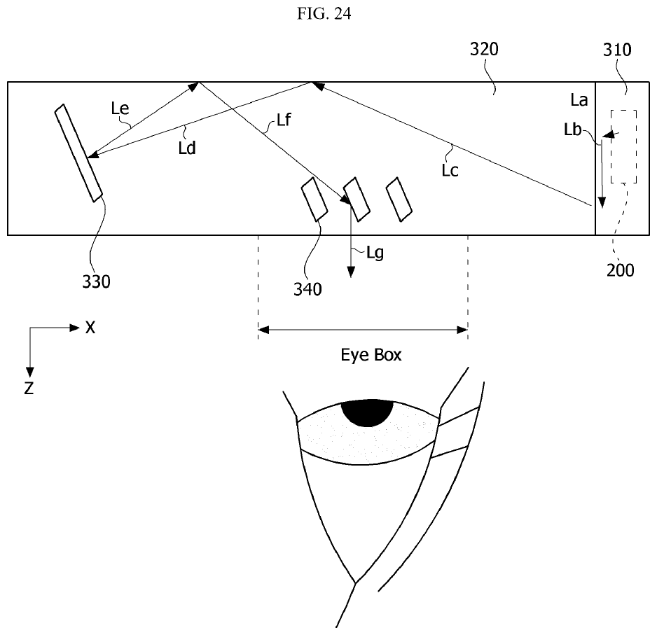

FIG. 21 is a perspective view of an electronic device including an optical device according to a fifth embodiment, FIG. 22 is a perspective view of the optical device according to the fifth embodiment, FIG. 23 is a front view of the optical device according to the fifth embodiment, and FIG. 24 is a side view of the optical device according to the fifth embodiment.

Referring to FIGS. 21 to 24, the electronic device including the optical device according to the fifth embodiment may include a frame 100 and an optical device OE as described above. Further, the optical device OE according to the fifth embodiment may include a projector 200 and a display unit 300. Accordingly, the electronic device may include the frame 100, the projector 200, and the display unit 300. More specifically, the optical device OE according to the fifth embodiment may include the projector 200, a guide unit 310, an optical member 320, a first optical element 330, and a second optical element 340. Further, except for the contents described below, the contents described in various embodiments can be applied to this embodiment.

The guide unit 310 may be located on a side surface of the optical member 320. In an embodiment, as described above, the guide unit 310 and the first optical element 330 may be located on a long side or a short side of the optical member 320. For example, the optical member 320 may have a first surface that is a long side in the front view or a cross section (XY plane) and a second surface corresponding to the first surface. Further, the optical member 320 may have a third surface that is a short side in the front view or a cross section (XY plane) and a fourth surface corresponding to the third surface. In this case, the guide unit 310 and the first optical element 330 may be disposed on the third surface and the fourth surface, respectively. For example, the guide unit 310 may be disposed adjacent to the third surface (or the fourth surface), and the first optical element 330 may be disposed adjacent to the fourth surface (or the third surface).

Further, the projector 200 may be located adjacent to the guide unit 310. For example, the projector 200 may be located on the upper or lower surface of the optical member 320, or on a side frame. Further, in an embodiment, the reflection region of the guide unit 310 may reflect the guided light to the optical member 320. The reflection region may reflect light in a direction parallel to the second direction. For example, the reflection region may reflect light in a direction opposite to the second direction and transmit the light to the optical member 320.

Furthermore, the second optical element 340 may be located between the first optical element 330 and the guide unit 310. The second optical element 340 may overlap the first optical element 330 and the guide unit 310 in the second direction (Y-axis direction).

The maximum length of the reflection region RA of the guide unit 310 in the first direction (X-axis direction) may be less than or equal to the maximum length of the first optical element 330 in the first direction (X-axis direction). With this configuration, the optical efficiency can be improved through the first optical element 330. Accordingly, the performance of the electronic device can be improved and reliability can also be enhanced due to heat generation or the like.

Additionally, the first optical element 330 may be located so that at least a portion thereof is offset from the second optical element 340 in the second direction (Y-axis direction). Further, the maximum length of the first optical element 330 in the first direction (X-axis direction) may be greater than the maximum length of the second optical element 340 in the first direction (X-axis direction). For example, the maximum length of the first optical element 330 in the first direction (X-axis direction) may be less than or equal to the length of the eye box in the first direction. With this configuration, the first optical element 330 can perform a function as a more improved collimator. Further, light reflected from the first optical element 330 may be transmitted to the second optical element 340 at a high rate.

Further, the first optical element 330 may be concave in the second direction (Y-axis direction). That is, the first optical element 330 may be convex toward an adjacent optical member or a nose pad (or the center of the front frame). Further, the first optical element 330 may be located adjacent to the optical member or the nose pad (or the center of the front frame) adjacent to the projector 200.

At least a part of the guide unit 310 may overlap the first optical element 330 in the second direction (Y-axis direction). Further, the guide unit 310 may also overlap the optical member 320 in the second direction (Y-axis direction).

The optical path in the optical device OE may be applied in the same manner as described above. First, light La of the virtual image emitted from the projector may be guided along the guide unit 310 (Lb) and reflected toward the optical member 320 in the reflection region RA of the guide unit 310 (Lc). In this case, the guide unit 310 may be disposed on the short side of the optical member 320 so that light is guided in a direction opposite to the first direction. Further, light transmitted to the optical member 320 may be transmitted to the first optical element 330 embedded in the inside of the optical member 320. In this case, light reflected from the guide unit 310 may proceed toward the center of the nose pad or the front frame. Additionally, light of the virtual image reflected in the reflection region RA may travel toward the inner surface of the optical member 320 and may be reflected (for example, totally reflected) from the inner surface and transmitted to the first optical element 330 (Ld). This enables the miniaturization of the optical device.

Furthermore, light Le reflected from the first optical element 330 may be reflected to the inner wall surface of the optical member 320. Further, light Lf reflected from the inner wall surface may be transmitted to the second optical element 340. In this case, light may be transmitted from the first optical element 330 to the second optical element 340 without passing through the inner wall surface. Further, the second optical element 340 may emit light Lg to the user (or right eye/left eye or the like) by a pinhole effect or the like.

The features, structures, effects, etc. described in the embodiments above are included in at least one embodiment, and are not necessarily limited to only one embodiment. Furthermore, the features, structures, effects, and the like exemplified in each of the embodiments may be combined or modified and implemented in other embodiments by a person having ordinary knowledge in the field to which the embodiments belong. Therefore, the contents related to these combinations and modifications should be interpreted as being included within the scope of the embodiments.

Although the above description has been made focusing on examples, these are merely examples and do not limit the present invention, and those with ordinary knowledge in the field to which the present invention belongs will recognize that various modifications and applications not exemplified above are possible without departing from the essential characteristics of these examples. For example, each component specifically shown in the examples may be modified and implemented. Further, the differences related to these modifications and applications should be interpreted as being included within the scope of the present invention defined in the appended claims.

1. An optical device comprising:
a light source unit;
an optical modulator disposed spaced apart from the light source unit;
a reflective member that reflects light emitted from the light source unit to the optical modulator;
an optical member disposed adjacent to the light source unit;
a first optical element disposed in the optical member; and
a plurality of second optical elements disposed between the optical modulator and the first optical element in the optical member,
wherein the optical member overlaps the optical modulator in a first direction, and
the first direction is a direction from the first optical element toward the optical modulator.

2. The optical device of claim 1, wherein the optical modulator is disposed on an upper surface of the optical member and overlaps the light source in a second direction perpendicular to the first direction.

3. The optical device of claim 1, wherein at least a part of the optical modulator overlaps the first optical element in the first direction.

4. The optical device of claim 1, wherein a center of the optical modulator corresponds to a center of the first optical element in a second direction.

5. The optical device of claim 4, wherein the center of the optical modulator is located within 0.2 times a length in the second direction from the center of the first optical element in the second direction.

6. The optical device of claim 1, wherein a center of at least one of the plurality of second optical elements, the first optical element, and the optical modulator is disposed to be misaligned with a center of the optical member.

7. The optical device of claim 1, wherein a length of the optical modulator in a third direction is greater than a length of the first optical element in the third direction, and
the third direction is a direction perpendicular to the first direction.

8. The optical device of claim 1, wherein a length of the optical modulator in a second direction is less than or equal to a length of the plurality of second optical elements or the first optical element in the second direction.

9. The optical device of claim 1, wherein the first optical element reflects light reflected from the optical modulator to the plurality of second optical elements.

10. The optical device of claim 1, wherein at least a part of the first optical element is offset from the optical modulator in the first direction.

11. The optical device of claim 1, wherein a length of the optical member in a third direction is greater than or equal to a length of the first optical element in the third direction.

12. The optical device of claim 1, wherein a length of the optical member in a third direction is greater than or equal to a length of the optical modulator in the third direction.

13. The optical device of claim 1, wherein the plurality of second optical elements are offset from or overlap the first optical element in the first direction.

14. The optical device of claim 1, wherein the light source unit includes a first light source and a second light source.

15. The optical device of claim 14, wherein the optical modulator is disposed between the first light source and the second light source.

16. The optical device of claim 1, wherein the first optical element and the second optical element are disposed closer to one side surface of the optical member than to an other side surface of the optical member.

17. An electronic device comprising:
a frame; and
an optical device mounted on the frame,
wherein the optical device includes: a light source unit; an optical modulator disposed spaced apart from the light source unit; a reflective member configured to reflect light emitted from the light source unit to the optical modulator; an optical member disposed adjacent to the light source unit; a first optical element disposed in the optical member; and a plurality of second optical elements disposed between the optical modulator and the first optical element in the optical member, wherein the optical member overlaps the optical modulator in a first direction, and the first direction is a direction from the first optical element toward the optical modulator.

18. The electronic device of claim 17, wherein the optical modulator is disposed on an upper surface of the optical member and overlaps the light source in a second direction perpendicular to the first direction.

19. The electronic device of claim 17, wherein at least a part of the optical modulator overlaps the first optical element in the first direction.

20. The electronic device of claim 17, wherein a center of the optical modulator corresponds to a center of the first optical element in a second direction.
